(19) United States
(12) Patent Application Publication
(10) Pub. No.: US 2002/0185417 A1
(43) Pub. Date: Dec. 12, 2002

(54) Apparatus for the treatment of domestic water

(76) Inventor: Ali Jose Galindez Bastida, Caracas (VE)

Correspondence Address: Laleh Jalai, KENYON & KENYON, 1500 K Street, N.W., Suite 700, Washington, DC, 20005, US

(21) Appl. No.: 09/877,840

(22) Filed: Jun. 8, 2001

(51) Int. Cl. B01D 17/12

(52) U.S. Cl. 210/143; 210/109; 210/106; 210/258; 210/259

(57) ABSTRACT

The present invention concerns an apparatus for the depuration of drinkable water for domestic use comprising at least an active coal filter, a volumetric pump, a nanofiltration membrane and a regulation and control system.

### FIELD OF THE INVENTION

The present invention relates to an apparatus for the deputation of drinkable water for domestic use, based on the use of a nanofiltration membrane.

### BACKGROUND OF THE INVENTION

Pollution of the water-bearing stratums represents a danger for public health that caused alarm in the public during recent years. The companies in charge of the distribution of drinkable water do their best to assure this service while maintaining the specs of water within the limits fixed by law. Nevertheless, the consumption of mineral water has increased steadily in the last years.

Objective of the present invention is the provision of a simple and economic system to improve quality of tap water by using a water purification apparatus based on a nanofiltration membrane.

### SUMMARY OF THE INVENTION

The invention relates to an apparatus for the depuration of drinkable water for domestic use comprising at least an active coal filter, a volumetric pump, a nanofiltration membrane and a regulation and control system. Such an apparatus guaranties the delivery of high purity water in standard conditions of municipal waterworks, with limited maintenance and, thus, a convenient cost.

### DETAILED DESCRIPTION OF THE INVENTION

The present invention provides an apparatus for the purification of domestic tap water based on the use of a nanofiltration membrane that guaranties the lowering of pollutants (organic solvents, bacteria, pesticides, and the like) while maintaining a sufficient level of mineral salts.

The apparatus consists of various electronic, electro-mechanic and pneumatic components assembled in such a way to effectively realize the nanofiltration process.

The apparatus comprises at least an active coal filter, optionally a sediment filter, a volumetric pump, a nanofiltration membrane and a regulation and control system.

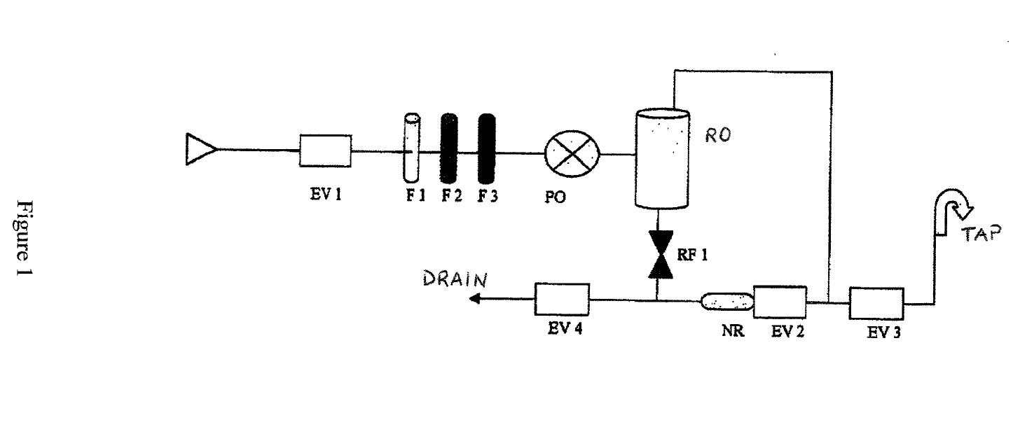

FIG. 1 shows a preferred but not limiting embodiment of the invention. The apparatus of FIG. 1 comprises:

1. an entrance, command and regulation section

2. a section comprising the nanofiltration unit

3. a control section.

The entrance, command and regulation section preferably consists of:

Electrovalve EV1, normally closed, that also plays a control role over possible water leakages (Automatic water block).

Sediment filter F1, preferably with a filtering degree of 5 microns.

Two active coal filters F2 and F3

An engine and a volumetric pump PO.

A regulation valve RF1 for the regulation of the percentage of water to the drain-pipe.

Electrovalve EV2 for the “automatic washing” function.

Electrovalve EV3 on the filtered water.

Electrovalve EV4 and non-return valve NR on the drain-pipe.

The nanofiltration section essentially comprises the unit RO wherein the nanofiltration membrane is placed. The unit RO is made of a material capable of standing the pressure deriving from the waterworks plus the prevalence of the pump. Preferably the unit RO is made of stainless steel.

The control section preferably comprises a microprocessor studied and developed for the correct working and control of the apparatus. An on-off switch on the outside of the apparatus and a switch for the delivery of filtered water, located at the base of the tap. The microprocessor controls in real time the functionality of the apparatus, visualizing the running function through a display.

The display visualizes the various messages concerning the status and the control functions of the apparatus.

Preferably, the microprocessor is connected to a probe for the detection of water leakages, called antifloading probe, a probe for detecting the presence of water in the pipeline and a probe for detecting the quality of water.

In a preferred embodiment, the microprocessor, at regular intervals, activates a washing cycle of the filters, the nanofiltration membrane and the pipelines. Such interval preferably varies between 4 and 12 hours, more preferably it is of about 8 hours.

Furthermore, the microprocessor can be connected to a system for the remote control of the functionality of the apparatus.

The power of the engine used for the volumetric pump depends on the water flow required; preferably it varies from 0.1 and 1 HP. The obtained water flow varies consequently between about 200 and 600 l/h. In a particularly preferred embodiment a 0.25 HP engine is used resulting in a water flow of about 360-480 l/h.

The preferred nanofiltration membranes are those which can guarantee enough selectivity towards the components that need to be removed from water.

For example, preferred membranes remove at least 70% of organic compounds and from 50 to 90% of the inorganic salts, depending on the valence of the ions (increasing the valence, increases the percentage of removal).

Such membranes have usually an operating range between 5 and 40° C.

The use of active coal filters is important to remove from water chlorine which, if interacting with the nanofiltration membrane, sensibly reduces its life.

The functioning of the nanofiltration apparatus according to the present invention is preferably completely automated.

After installation and when switching the apparatus on, the apparatus is posed on hold; in this condition all the probes possibly present (probe for the detection of water leakages, probe for detecting the presence of water in the pipeline, probe for detecting the quality of water, etc.) become active.

When pushing the switch on the basis of the tap, the microprocessor is activated. It opens EV1 allowing water to enter the apparatus and to pass through filters F1, F2 and F3 and to reach the pump.

The volumetric pump guaranties a constant flow of water. Such a flow is split inside the filtering unit in a filtered fraction, which reaches the tap, and a discarded fraction. The ratio between filtered and discarded fractions is fixed through regulation of the valve RF1 during assembly of the apparatus. The preferred ratio filtered/discarded water is about 3, which corresponds to a flow of filtered water of 50-150 l/h, more preferably 90-120 l/h. The function of the discarded water is to maintain the surface of the membrane clean, avoiding accumulation of organic compounds and inorganic salts on the same.

1. Apparatus for the depuration of drinkable water for domestic use comprising at least an active coal filter, a volumetric pump, a nanofiltration membrane and a regulation and control system.

2. Apparatus according to claim 1 further comprising a sediment filter.

3. Apparatus according to claim 1 comprising two active coal filters.

4. Apparatus according to claim 1 wherein the volumetric pump provides a water flow comprised between about 200 and 600 l/h.

5. Apparatus according to claim 1 wherein the nanofiltration membrane removes at least 70% of the organic compounds present in the inlet water.

6. Apparatus according to claim 1 wherein the control section comprises a microprocessor studied and developed for the correct working and control of the apparatus, an on-off switch on the outside of the apparatus and a switch for the delivery of filtered water, located at the base of the tap.

7. Apparatus according to claim 6 wherein the microprocessor is connected to a probe for the detection of water leakages, called antifloading probe, a probe for detecting the presence of water in the pipeline and a probe for detecting the quality of water.

8. Apparatus according to claim 6 wherein the microprocessor, at regular intervals of 4-12 hours activates a washing cycle of the filters, the nanofiltration membrane and the pipelines.

9. Apparatus according to claim 6 wherein the microprocessor is connected to a system for the remote control of the functionality of the apparatus.
